(19) United States
(12) Patent Application Publication
(10) Pub. No.: US 2010/0282239 A1
(43) Pub. Date: Nov. 11, 2010

(54) COMMERCIAL CHARBROILER WITH INTEGRATED CATALYTIC HOOD

(75) Inventor: James T. Cole, Algonquin, IL (US)

Correspondence Address: MARK E. FEJER;GAS TECHNOLOGY INSTITUTE, 1700 SOUTH MOUNT PROSPECT ROAD, DES PLAINES, IL, 60018, US

(73) Assignee: GAS TECHNOLOGY INSTITUTE, Des Plaines, IL (US)

(21) Appl. No.: 12/435,593

(22) Filed: May 5, 2009

(51) Int. Cl. A47J 37/00; F24C 15/20; F24C 3/12

(52) U.S. Cl. 126/41 R; 126/299 D; 126/39 G

(57) ABSTRACT

A cooking appliance having a cooking surface, a housing enclosing a heating source for heating the cooking surface disposed beneath the cooking surface, and a vertically movable cooking fume hood connected with the housing and having a cooking fume exhaust opening proximate a top of the hood. The cooking surface may be a grid-type cooking surface or a griddle-type cooking surface or a combination thereof. The heating source preferably is a gaseous fuel-fired burner.

### BACKGROUND OF THE INVENTION

1. Field of the Invention

This invention relates to commercial, i.e. restaurant class, cooking appliances. In one aspect, this invention relates to cooking appliances which produce effluents during the cooking process. In another aspect, this invention relates to commercial cooking appliances featuring grid or griddle cooking. In another aspect, this invention relates to commercial charbroilers.

2. Description of Related Art

In a grid type of cooking appliance, the cooking surface comprises a number of spaced apart rods upon which the food product is supported during the cooking process. The heat causes grease to drip out of the food onto a hot surface on which it is burned, creating particulates of grease and cooking oil, i.e. smoke, which not only affects the taste of the food, but which must also be disposed of in an environmentally acceptable manner. In a griddle type of cooking appliance, the cooking surface is a flat sheet of metal upon which the food is cooked, producing particulates of grease and cooking oil in the process which must also be disposed of in an environmentally acceptable manner. In both cases, heat is provided to the underside of the grid support or griddle by heating means disposed in an enclosure below the cooking surface.

As indicated, the cooking of food on these types of appliances produces large quantities of cooking effluents which include particulate emissions, such as droplets of grease and cooking oils, carbon monoxide and hydrocarbon-derived gases, including reactive organic gases. If left untreated, these effluents are released into the atmosphere. There have been numerous attempts to develop technologies suitable for cleanup of the effluents from underfired cooking appliances, such as charbroilers. Typically, these technologies are applied after the effluent has been collected in an exhaust hood.

Traditionally, restaurant kitchens are ventilated by capturing the cooking effluents and, in the case of gas-fired appliances, combustion products in an exhaust hood and transporting the grease-laden exhaust airflow from the inside of the building to the outdoors through welded steel ducts. The grease load in the welded steel ducts is reduced by fitting the hoods with a baffler or slot filters that remove the heavier grease particles by impaction. The smaller, lighter grease particles and grease vapors bypass these filters and deposit on the duct walls and the building, creating fire and safety issues.

However, such traditional kitchen ventilation systems are expensive, in no small part because of the welded steel ductwork, resulting in acceptance of recirculating ventilation technology that does not require the removal of all exhaust airflow from the building. Such recirculating ventilation technology typically includes a hood and a grease filtering element to capture grease from the cooking effluents and combustion products from the gas-fired appliance. An odor removal or control element is also positioned within the hood together with a blower to return the scrubbed air back to the interior of the building. A fire suppression device is also required to control the dangers associated with ignition of grease or other combustion products.

The grease filtering element according to related art devices may comprise an electronic air cleaner such as an electrostatic precipitator (ESP) or HEPA filters. Such electronic air cleaners are often used to filter air drawn into the building and more recently are used to clean grease-laden exhaust airflow prior to recirculation back into the building. These systems must have fire suppression devices because the electronic air cleaners use a high field voltage and may act as an ignition source. Further, grease may collect within the device and may ignite if a fire starts in an appliance positioned beneath the device.

Several existing recirculation ventilation units featuring ESP technology followed by charcoal granular filters are now in use. In such devices, the ESP modules are largely effective only in removing grease particles and droplets with little impact on grease vapor and cooking odors. However, grease vapor may account for approximately 50-60% by weight of the grease emitted during frying and approximately 40% by weight of the grease emitted during char-broiling. Given the apparent lack of effectiveness of the ESP modules in removing grease vapor, the charcoal filters located upstream become coated with grease vapor and are thus only marginally effective with respect to their primary function, odor control. Finally, the ESP modules must be maintained on a regular, often times daily basis to clean grease from internal plates or the performance of the ESP modules quickly drops off.

One of the problems of conventional cleanup systems is that the required exhaust rates for charbroilers is such that the effluent temperature will normally be well below 400° F., the temperature required to maintain the activity of catalysts employed in the exhaust hoods. And while electrostatic precipitators may be employed, they typically require daily cleaning to avoid arcing and are extremely difficult to apply as a retrofit technology, a requirement of pending rules in California.

### SUMMARY OF THE INVENTION

It is, thus, one object of this invention to provide a charbroiler capable of reducing the emissions of cooking effluents compared with conventional charbroilers.

It is another object of this invention to provide a charbroiler capable of reducing the emission of cooking effluents compared with conventional charbroilers which is able to be retrofit into existing commercial appliance exhaust hood installations.

These and other objects of this invention are addressed by a cooking appliance comprising a cooking surface, a housing having upwardly extending side and back walls and enclosing heating means for heating the cooking surface disposed beneath the cooking surface, and a vertically movable cooking fume hood connected with the housing and having a cooking fume exhaust opening proximate a top of the hood. The cooking surface may be a grid-type cooking surface or a griddle-type cooking surface or a combination thereof. Heating means for heating the cooking surface may comprise one or more gaseous fuel-fired burners disposed in an enclosure or housing beneath the cooking surface. As a consequence, it will be appreciated by those skilled in the art that combustion products from gaseous fuel-fired burners may be mixed with the cooking fumes produced by the cooking process, particularly with grid-type cooking surfaces. Alternatively, said heating means may comprise one or more electric heating elements.

### BRIEF DESCRIPTION OF THE DRAWINGS

These and other objects and features of this invention will be better understood from the following detailed description taken in conjunction with the drawings wherein:

FIG. 1 is a perspective view of a cooking appliance in accordance with one embodiment of this invention in which the cooking fume hood and movable front wall are disposed in a lowered position;

FIG. 2 is a perspective view of a cooking appliance in accordance with one embodiment of this invention with the cooking fume hood disposed in a lowered position and the movable front wall disposed in a vertically raised position; and

FIG. 3 is a perspective view of a cooking appliance in accordance with one embodiment of this invention with both the cooking fume hood and the movable front wall disposed in a raised position.

### DETAILED DESCRIPTION OF THE PRESENTLY

### Preferred Embodiments

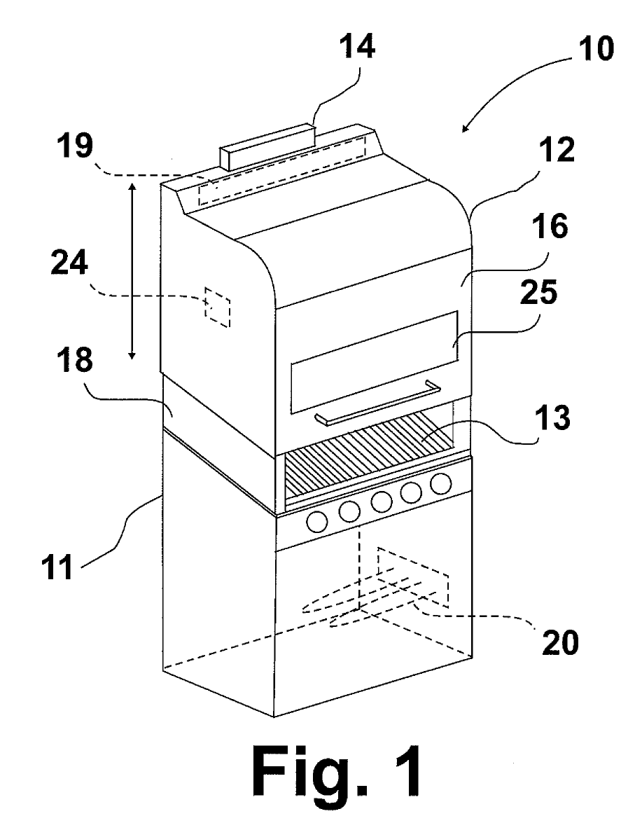

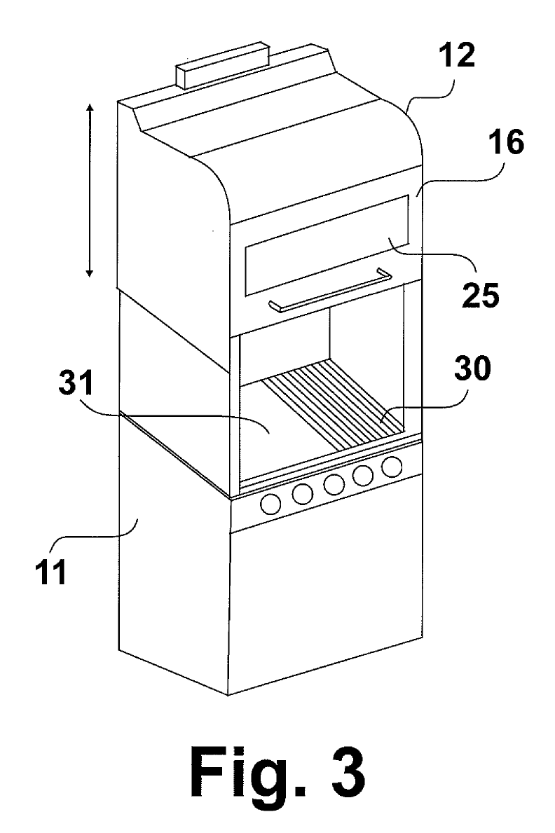

FIG. 1 shows a cooking appliance 10 in accordance with one embodiment of this invention comprising a cooking surface 13, a housing 11 having upwardly extending back and side walls, 17, 18 around the cooking surface and enclosing heating means for heating the cooking surface below the cooking surface. The cooking surface may be a grid type surface, a griddle type surface, or a combination of a grid type 30 and griddle type 31 surface, as shown in FIG. 3. In accordance with one embodiment of this invention, said heating means comprises at least one gaseous fuel burner 20. In accordance with another embodiment of this invention, said heating means are in the form of electric heating elements. Disposed above the cooking surface is a vertically movable cooking fume hood 12, shown in a lowered position, connected with housing 11. Cooking fume hood 12 comprises a vertically movable wall or door 16, shown in a lowered position, on the front side of the hood. Mechanics of raising and lowering the cooking fume hood and door, such as the use of rails or interlocking slide or glide mechanisms, are known in the art and, thus, will not be described in detail herein. To obtain the desired benefits of this invention, the cooking fume hood 12, together with the vertically movable wall or door 16, should be positioned in their lowered positions during cooking. In this way, the amount of air from the surroundings entering into the cooking fume hood is maintained at a relatively low level, to ensure that the temperatures of the cooking fumes are as high as possible. Cooking fume hood 12 is provided with a cooking fume exhaust opening 14 proximate the top of the hood through which the cooking fumes produced during the cooking process are exhausted. Disposed within the cooking fume hood proximate the cooking fume exhaust opening is a catalyst 19 suitable for incinerating the particulate emissions in the cooking fumes. Suitable catalysts for use in this invention are available, for example, from BASF Catalysts LLC, Iselin, N.J. Maintaining the cooking fume temperature as high as possible is important for ensuring the long term effectiveness of the catalyst.

With the cooking fume hood in a lowered position, the energy demand to cook the product on the cooking surface is reduced compared with conventional comparable cooking appliances without such a hood. By using a thermostat 24 disposed within the area enclosed by the cooking fume hood, the heating means may be modulated to reduce energy consumption.

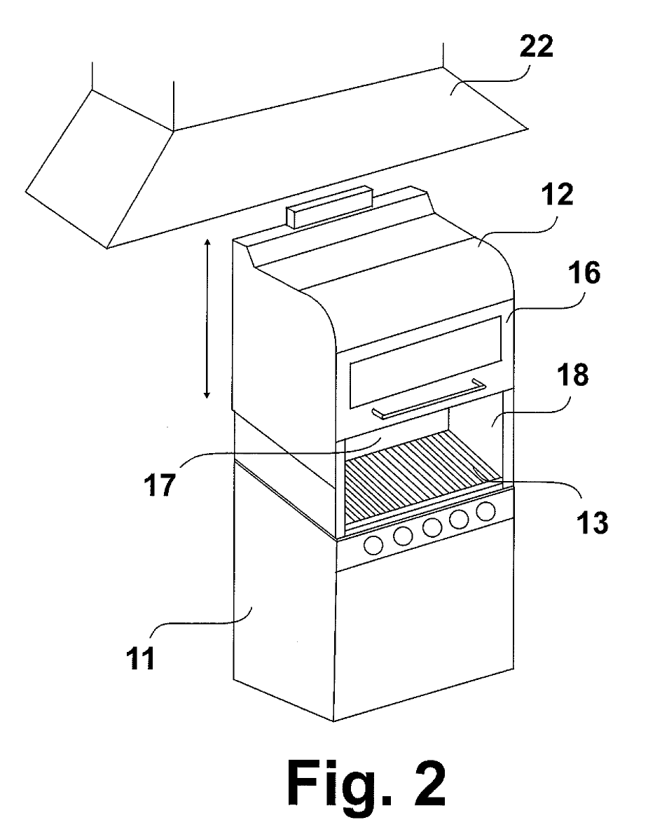

It will be appreciated by those skilled in the art that one of the requirements for use of a cooking appliance is the ability of the operator to see the food as it is being cooked and that disposition of the cooking fume hood of this invention in a lowered position may block the view of the operator. This issue may be addressed in accordance with one embodiment of this invention in which a portion of the vertically movable wall or door 16 comprises a transparent window 25, enabling the operator to see into the area below the hood. Alternatively, the vertically movable wall or door 16 may be raised and lowered as necessary independently of the cooking fume hood as shown in FIG. 2 to provide an unimpeded view of the cooking surface. For complete, unimpeded access to the cooking surface for loading and flipping of the product on the cooking surface, both the cooking fume hood and the wall or door are raised. In this way, the integrity of the hot cooking fumes collected under the hood is maintained so as to maintain the desired cooking fume temperature, i.e. greater than about 400° F.

One of the requirements of pending regulations as discussed herein above is that the improved cooking appliances be retrofittable with respect to the hood systems currently employed for cooking effluent control. While it may be possible to merely add a cooking fume hood in accordance with this invention to an existing cooking appliance, the more likely scenario is that the improved cooking appliance will be inserted as a unit in place of an existing cooking appliance beneath an existing hood system 22, as shown in FIG. 2.

While in the foregoing specification this invention has been described in relation to certain preferred embodiments thereof, and many details have been set forth for the purpose of illustration, it will be apparent to those skilled in the art that the invention is susceptible to additional embodiments and that certain of the details described herein can be varied considerably without departing from the basic principles of this invention.

What is claimed is:

1. In an underfired charbroiler having a front side, a backside, a housing enclosing a burner compartment, and a cooking surface disposed above said burner compartment, the improvement comprising:
a vertically movable cooking fume hood connected with said housing disposed above said cooking surface and forming a cooking fume exhaust opening proximate a top of said cooking fume hood.

2. The underfired charbroiler of claim 1, wherein said cooking fume hood comprises a vertically movable wall on said front side.

3. The underfired charbroiler of claim 1, wherein said cooking fume hood comprises a catalytic filter proximate said cooking fume exhaust opening suitable for incineration of particulate emissions generated while cooking on said cooking surface.

4. The underfired charbroiler of claim 1 further comprising a thermostatic control for modulating a burner disposed in an area defined by said cooking fume hood.

5. A cooking appliance comprising:
an underfired charbroiler disposed beneath an exhaust hood, said underfired charbroiler comprising a housing enclosing a burner compartment, a cooking surface disposed above said burner compartment, and an integral vertically movable cooking fume hood connected with said housing and having a cooking fume exhaust opening proximate a top of said cooking fume hood.

6. The cooking appliance of claim 5, wherein said cooking fume hood comprises a vertically movable wall on a front side of said cooking fume hood, said vertically movable wall being movable independently of said cooking fume hood.

7. The cooking appliance of claim 5, wherein said cooking fume hood comprises a catalytic filter proximate said cooking fume exhaust opening suitable for incineration of particulate emissions produced while cooking on said cooking surface.

8. The cooking appliance of claim 5 further comprising a thermostatic control for modulating a burner disposed in said burner compartment.

9. A cooking apparatus comprising:
a cooking surface;
a housing enclosing heating means for heating said cooking surface disposed beneath said cooking surface; and a vertically movable cooking fume hood connected with said housing and having a cooking fume exhaust opening proximate a top of said hood.

10. The cooking apparatus of claim 9, wherein said cooking fume hood comprises an independently vertically movable wall on a front side on said hood.

11. The cooking apparatus of claim 9, wherein said cooking fume hood comprises a catalytic filter proximate said cooking fume exhaust opening suitable for incineration of particulate emissions produced by cooking on said cooking surface.

12. The cooking apparatus of claim 9 further comprising a thermostatic control for modulating said heating means.

13. The cooking apparatus of claim 9, wherein said heating means comprises at least one gaseous fuel-fired burner.

14. The cooking apparatus of claim 9 further comprising an exhaust hood disposed above said cooking fume hood.
